(19) United States
(12) Patent Application Publication
(10) Pub. No.: US 2012/0293571 A1
(43) Pub. Date: Nov. 22, 2012

(54) IMAGE DISPLAY DEVICE

(75) Inventor: Toshiyuki Gotoh, Osaka-Shi (JP)

(73) Assignee: Sharp Kabushiki Kaisha, Osaka-shi (JP)

(21) Appl. No.: 13/576,577

(22) PCT Filed: Dec. 15, 2010
(86) PCT No.: PCT/JP2010/072577

§ 371 Date: Aug. 1, 2012

(30) Foreign Application Priority Data
Feb. 26, 2010 (JP) 2010-043096

(51) Int. Cl. G09G 5/10

(52) U.S. Cl. 345/690

(57) ABSTRACT

An image display device of the present invention includes a subframe generation section (10) for dividing one frame of a video signal into a first subframe during which at least a green (G) light source emits light, a second subframe during which at least a red (R) light source emits light, and a third subframe during which a blue (B) light source emits light. The subframe generation section (10) finds a difference between (i) a signal to be displayed, which signal is obtained from an aperture ratio corrected in the first subframe and luminance distribution of a light source corresponding to a red (R) video signal included in the first subframe and (ii) the red (R) video signal included in the first subframe, and corrects, according to the difference found in the first subframe, an aperture ratio corrected in the second subframe. This prevents insufficiency of luminance, and thus makes it possible to carry out an accurate color display.

### REFERENCE TO RELATED APPLICATIONS

This application is a national stage application under 35 USC 371 of International Application No. PCT/JP2010/072577, filed Dec. 15, 2010, which claims priority from Japanese Patent Application No. 2010-043096 filed Feb. 26, 2010, the entire contents of which are incorporated herein by reference.

### FIELD OF THE INVENTION

The present invention relates to an image display device capable of color display. In particular, the present invention relates to an image display device that carries out a color display by a field sequential system.

### BACKGROUND OF THE INVENTION

Generally, many of color display devices such as television receivers and monitors of personal computers, which serve as image display devices capable of color display, reproduce images by a color mixing method using three primary colors of red, green and blue. The method is called an additive process.

Current general color display devices carry out a color display with use of a color filter colored with R (red), G (green) and B (blue).

On the other hand, there have also been proposed color display devices that carry out a color display without using a color filter. For example, there is proposed a color display device employing a field sequential system in which red, green and blue backlights are caused to emit light sequentially. An example of such a color display device employing the field sequential system is a liquid crystal display device disclosed in Patent Literature 1. According to the liquid crystal display device, a color display is carried out such that (i) a single frame is divided into three subframes corresponding to R, G and B, respectively and (ii) red, green and blue backlights are caused to emit light sequentially.

However, the field sequential system causes the following problem. That is, since a single frame is divided simply into three subframes corresponding to respective R, G and B image signals, some images may not be displayed with appropriately mixed RGB colors in that frame. This may cause color breaking (CB), and thus results in a reduction in display quality.

In view of this, for example Patent Literature 2 discloses the following method. That is, instead of dividing a single frame simply into three subframes corresponding to the respective R, G and B image signals, (i) a single TV field period is divided into three subfields, (ii) during one subframe, an entire G image signal and also displayable part of R and B image signals are displayed and (iii) during the other two subframes, the rest of the R and B image signals, which were not displayed in the first subframe, are displayed (see FIG. 9), thereby CB is reduced.

Japanese Patent Application Publication, Tokukaihei, No. 5-346570 A (Publication Date: Dec. 27, 1993)

Japanese Patent Application Publication, Tokukai, No. 2009-134156 A (Publication Date: Jun. 18, 2009)

### SUMMARY OF THE INVENTION

However, the method disclosed in Patent Literature 2 has the following problem. In a case where, in a single frame, there is an object which has a color close to white and whose luminance level is lower in an R image signal and/or a B image signal than in a G image signal, the R and B image signals are not displayed during a subframe during which the entire G image signal is displayed. This causes CB as is the case with a conventional system, in which a single frame is divided simply into three subframes corresponding to the respective R, G and B image signals so as to be displayed.

In order to reduce occurrence of CB in a color display device employing the field sequential system, for example it is possible to employ an area active control in which a backlight is controlled for each display area.

However, usually, the area active control uses an LED backlight. Therefore, although the area active control can reduce occurrence of CB, some images may be insufficient in luminance if correction is carried out simply in consideration of luminance distribution of the LED for faithful reproduction of an original image.

If luminance is not sufficient like above, the image displayed is different in color from the original image. That is, a color display cannot be carried out accurately.

The present invention has been made in view of the above problem, and an object of the present invention is to provide an image display device capable of preventing insufficiency of luminance and thus carrying out a color display accurately.

In order to attain the above object, the present invention provides an image display device including: display means having a display region, the display region being constituted by a plurality of pixels each having light transparency; and a backlight constituted by a plurality of light sources for backlighting the display region of the display means with light of different colors, said image display device displaying a color image by controlling, in accordance with an inputted video signal, an aperture ratio indicative of transmittance, of the plurality of pixels in the display means, for the light emitted from the plurality of light sources of the backlight, wherein one frame of the video signal is divided into a first subframe during which at least a light source of a first color emits light, a second subframe during which at least a light source of a second color emits light, and a third subframe during which a light source of a third color emits light, a first aperture ratio corresponding to a pixel of the first color is corrected on the basis of a video signal of the first color included in the first subframe, a second aperture ratio corresponding to a pixel of the second color is corrected on the basis of a video signal of the second color included in the second subframe, a third aperture ratio corresponding to a pixel of the third color is corrected on the basis of a video signal of the third color included in the third subframe, a difference between (i) a signal to be displayed, which signal is obtained from the first aperture ratio corrected in the first subframe and luminance distribution of a light source corresponding to a video signal of the second color included in the first subframe and (ii) the video signal of the second color included in the first subframe is found, and the second aperture ratio corrected in the second subframe is corrected according to the difference found in the first subframe.

Further, the present invention provides an image display device including: display means having a display region, the display region being constituted by a plurality of pixels each having light transparency; and a backlight constituted by a plurality of light sources for backlighting the display region of the display means with light of different colors, said image display device displaying a color image by controlling, in accordance with an inputted video signal, an aperture ratio indicative of transmittance, of the plurality of pixels in the display means, for the light emitted from the plurality of light sources of the backlight, said image display device further including: a subframe generation section for dividing one frame of the video signal into a first subframe during which at least a light source of a first color emits light, a second subframe during which at least a light source of a second color emits light, and a third subframe during which a light source of a third color emits light, the subframe generation section including a first aperture ratio correction section for correcting, on the basis of a video signal of the first color included in the first subframe, a first aperture ratio corresponding to a pixel of the first color, a second aperture ratio correction section for correcting, on the basis of a video signal of the second color included in the second subframe, a second aperture ratio corresponding to a pixel of the second color, and a third aperture ratio correction section for correcting, on the basis of a video signal of the third color included in the third subframe, a third aperture ratio corresponding to a pixel of the third color, and the subframe generation section finding a difference between (i) a signal to be displayed, which signal is obtained from the first aperture ratio corrected by the first aperture ratio correction section in the first subframe and luminance distribution of a light source corresponding to a video signal of the second color included in the first subframe and (ii) the video signal of the second color included in the first subframe, and correcting, according to the difference found in the first subframe, the second aperture ratio corrected by the second aperture ratio correction section in the second subframe.

Further, the present invention provides a display method for an image display device, the image display device including (i) display means having a display region, the display region being constituted by a plurality of pixels each having light transparency and (ii) a backlight constituted by a plurality of light sources for backlighting the display region of the display means with light of different colors, the image display device displaying an image by controlling, in accordance with an inputted video signal, an aperture ratio indicative of transmittance, of the plurality of pixels of the display means, for the light emitted from the plurality of light sources of the backlight, said method, including the steps of: (1) generating subframes by dividing one frame of the video signal into a first subframe during which at least a light source of a first color emits light, a second subframe during at least a light source of a second color emits light, and a third subframe during which a light source of a third color emits light, the step (1) including a first aperture ratio correction step for correcting, on the basis of a video signal of the first color included in the first subframe, a first aperture ratio corresponding to a pixel of the first color, a second aperture ratio correction step for correcting, on the basis of a video signal of the second color included in the second subframe, a second aperture ratio corresponding to a pixel of the second color, and a third aperture ratio correction step for correcting, on the basis of a video signal of the third color included in the third subframe, a third aperture ratio corresponding to a pixel of the third color; (2) finding a difference between (i) a signal to be displayed, which signal is obtained from the first aperture ratio corrected by the first aperture ratio correction step in the first subframe and luminance distribution of a light source corresponding to a video signal of the second color included in the first subframe and (ii) the video signal of the second color included in the first subframe; and (3) correcting, according to the difference found in the first subframe, the second aperture ratio corrected by the second aperture ratio correction step in the second subframe.

According to the configurations, (i) one frame of a video signal is divided into three subframes and (ii) at least a light source of the first color emits light during the first subframe, at least a light source of the second color emits light during the second subframe, and a light source of the third color emits light during the third subframe. This makes it possible to carry out a color display of the video signal for the one frame.

Note, here, that color breaking may occur depending on video signals. To avoid this, in the first subframe, the light sources of the second and third colors can be caused to emit light in addition to the light source of the first color. That is, since color breaking may occur depending on video signals, red (R) and blue (B) light sources can be caused to emit light in the first subframe in addition to a green (G) light source.

Further, in the first subframe, the aperture ratio corresponding to the pixel of the first color is corrected on the basis of the video signal of the first color included in the first subframe. Therefore, an aperture ratio corresponding to a pixel of the second color and an aperture ratio corresponding to a pixel of the third color are the same as the aperture ratio corrected so as to correspond to the pixel of the first color. Accordingly, in a case where the aperture ratio thus corrected is smaller than what the aperture ratios corresponding to the pixels of the second and third colors should be, the second subframe and the third subframe will be insufficient in luminance.

In this regard, according to the configurations, the difference between (i) the signal to be displayed, which signal is obtained from the first aperture ratio corrected in the first subframe by the first aperture ratio correction section and the luminance distribution of the light source corresponding to the video signal of the second color included in the first subframe and (ii) the video signal of the second color included in the first subframe is found, and the second aperture ratio corrected in the second subframe by the second aperture ratio correction section is corrected according to the difference thus found in the first subframe. This makes it possible to compensate for the lack of luminance when the one frame is taken as a whole, and thus possible to appropriately display the video signals of the second and third colors.

This prevents insufficiency of luminance, and thus possible to achieve an image display device capable of accurate color display with the above three colors (first color, second color and third color).

It should be noted that the correction as above may cause the following problem. Although the aperture ratio for the second color, with which aperture ratio all the video signals are displayed, is corrected appropriately in the second subframe, the third subframe will be insufficient in luminance if the aperture ratio for the second color thus corrected is smaller than an aperture ratio obtained on the basis of the video signal of the third color.

If this is the case, the image display device can further be configured such that the subframe generation section: finds a first difference between (i) a signal to be displayed, which signal is obtained from the first aperture ratio corrected by the first aperture ratio correction section in the first subframe and luminance distribution of a light source corresponding to a video signal of the third color included in the first subframe and (ii) the video signal of the third color included in the first subframe; finds a second difference between (a) a signal to be displayed, which signal is obtained from the second aperture ratio corrected by the second aperture ratio correction section in the second subframe and luminance distribution of a light source corresponding to a video signal of the third color included in the second subframe and (b) the video signal of the third color included in the second subframe; and corrects, according to a sum of the first and second differences found in the first and second subframes, the third aperture ratio corrected by the third aperture ratio correction section in the third subframe.

According to the configuration, the aperture ratio corrected in the third subframe is corrected according to the sum of the above differences. This makes it possible to compensate for the lack of luminance when the single frame is taken as a whole, and thus possible to appropriately display the video signal of the third color.

Further, the image display device is preferably configured such that the plurality of light sources of the backlight are driven such that light sources in respective predetermined areas are driven independently of each other.

Since the backlight is driven by area active driving like above, it is possible to prevent, even if color breaking occurs, the color breaking from spreading out from a predetermined area of the backlight, which area is a small area. This makes it possible to reduce occurrence of color breaking when the backlight is taken as a whole.

The first, second and third colors are not particularly limited provided that these colors achieve a color display. In particular, it is preferable that the image display device be configured such that the first color is green (G), the second color is red (R), and the third color is blue (B). Alternatively, it is preferable that the image display device be configured such that the first color is yellow (Y), the second color is cyan (C), and the third color is magenta (M).

The present invention provides an image display device including: display means having a display region, the display region being constituted by a plurality of pixels each having light transparency; and a backlight constituted by a plurality of light sources for backlighting the display region of the display means with light of different colors, said image display device displaying a color image by controlling, in accordance with an inputted video signal, an aperture ratio indicative of transmittance, of the plurality of pixels in the display means, for the light emitted from the plurality of light sources of the backlight, said image display device further including: a subframe generation section for dividing one frame of the video signal into a first subframe during which at least a light source of a first color emits light, a second subframe during which at least a light source of a second color emits light, and a third subframe during which a light source of a third color emits light, the subframe generation section including a first aperture ratio correction section for correcting, on the basis of a video signal of the first color included in the first subframe, a first aperture ratio corresponding to a pixel of the first color, a second aperture ratio correction section for correcting, on the basis of a video signal of the second color included in the second subframe, a second aperture ratio corresponding to a pixel of the second color, and a third aperture ratio correction section for correcting, on the basis of a video signal of the third color included in the third subframe, a third aperture ratio corresponding to a pixel of the third color, and the subframe generation section finding a difference between (i) a signal to be displayed, which signal is obtained from the first aperture ratio corrected by the first aperture ratio correction section in the first subframe and luminance distribution of a light source corresponding to a video signal of the second color included in the first subframe and (ii) the video signal of the second color included in the first subframe, and correcting, according to the difference found in the first subframe, the second aperture ratio corrected by the second aperture ratio correction section in the second subframe. This prevents insufficiency of luminance, and thus makes it possible to achieve an image display device capable of accurate color display.

### BRIEF DESCRIPTION OF THE DRAWINGS

FIG. 1 is a block diagram schematically illustrating a liquid crystal display device in accordance with Embodiment 1 of the present invention.

FIG. 2 is a block diagram schematically illustrating a subframe generation section included in the liquid crystal display device shown in FIG. 1.

FIG. 3 is a block diagram schematically illustrating the sixth process block and the seventh process block in the subframe generation section shown in FIG. 2.

FIGS. 4 (a) and (b) of FIG. 4 are views showing how processes of displaying subframes of a video are carried out.

FIG. 5 is a view for describing control of a backlight included in the liquid crystal display device shown in FIG. 1.

FIG. 6 is a view illustrating, for each of R, G, and B colors, a relationship between a backlight luminance and a field period in the liquid crystal display device shown in FIG. 1.

FIGS. 7 (a) to (d) of FIG. 7 are views showing how processes of displaying subframes of the subject application are carried out.

FIGS. 8 (a) to (c) of FIG. 8 are views showing how conventional processes of displaying subframes are carried out.

FIG. 9 is a view illustrating, for each of R, G and B colors, a relationship between a backlight luminance and a field period in a conventional liquid crystal display device.

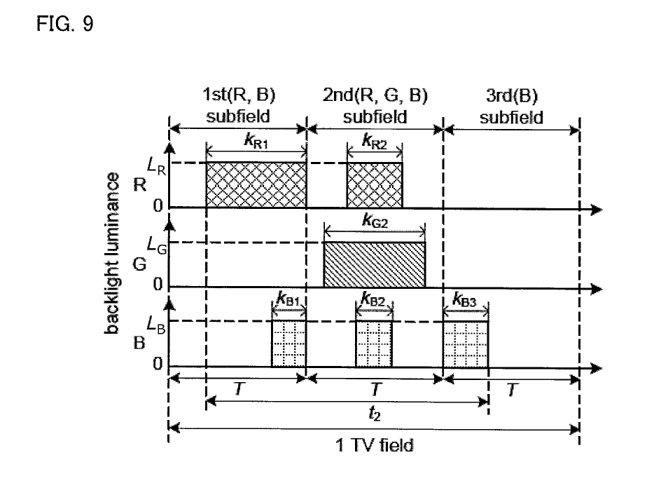

### DETAILED DESCRIPTION OF THE INVENTION

The following description discusses embodiments of the present invention in detail.

<Overall Description of Liquid Crystal Display Device>

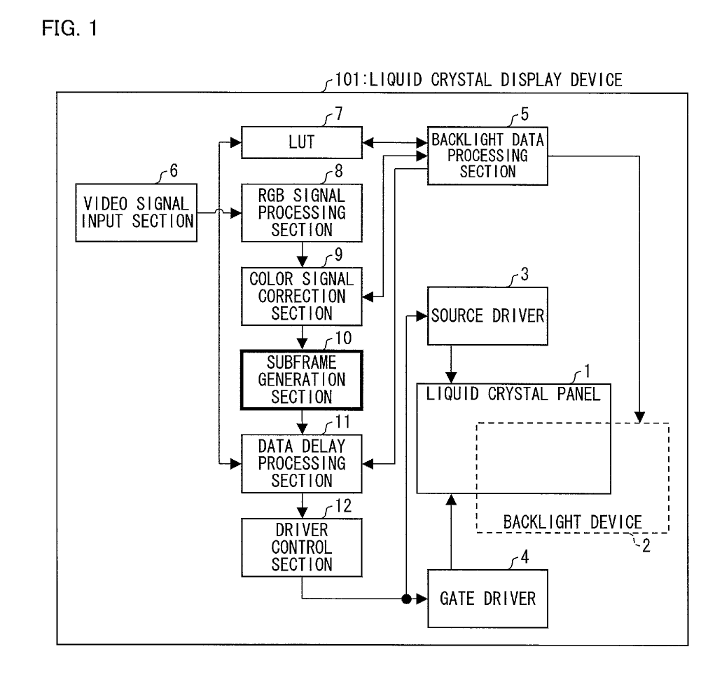

FIG. 1 is a block diagram schematically illustrating a liquid crystal display device, to which an image display device of the present invention is applied.

As illustrated in FIG. 1, a liquid crystal display device 101 includes: a liquid crystal panel (display means) 1 having a display region which is constituted by a plurality of pixels each having light transparency; a backlight device 2 constituted by a plurality of light sources for backlighting the display region of the liquid crystal panel 1 with light of different colors; a source driver 3; a gate driver 4; a backlight data processing section 5; a video signal input section 6; a LUT 7 (lookup table); an RGB signal processing section 8; a color signal correction section 9; a subframe generation section 10; a data delay processing section 11; and a driver control section 12.

The liquid crystal display device 101 is configured to (i) display color images by a field sequential system and (ii) carry out area active driving control by which to drive the light sources of the backlight such that light sources in respective predetermined areas are driven independently of each other. To achieve this, the liquid crystal panel 1 uses ferroelectric liquid crystal, which is high in response speed and is suitable for the field sequential system. The backlight device 2 employs an LED backlight system using a light emitting diode (LED) serving as a light emitting element. The backlight device 2 is configured such that a plurality of LEDs of R (red) serving as a first color, a plurality of LEDs of G (green) serving as a second color, and a plurality of LEDs of B (blue) serving as a third color are arranged in a plane.

That is, the liquid crystal display device 101 includes: the video signal input section 6 which receives a video signal from outside and processes the video signal; the LUT 7 which stores therein predetermined data in advance; and the RGB signal processing section 8 which is connected to the video signal input section 6. The liquid crystal display device 101 further includes: the color signal correction section 9, the subframe generation section 10, the data delay processing section 11, and the driver control section 12, which are connected in this order with the RGB signal processing section 8; the backlight data processing section 5 connected between the color signal correction section 9 and the data delay processing section 11; and the source driver 3 and the gate driver 4 connected with the driver control section 12.

The liquid crystal display device 101 is configured such that (i) the driver control section 12 supplies instruction signals to the source driver 3 and the gate driver 4 in accordance with a video signal supplied to the video signal input section 6 so that the liquid crystal panel 1 is driven pixel by pixel and (ii) the backlight data processing section 5 supplies an instruction signal to the backlight device 2 so that the LEDs constituting the backlight device 2 are driven to be turned on.

The video signal input section 6, the LUT 7, the RGB signal processing section 8, the color signal correction section 9, the subframe generation section 10, the data delay processing section 11, the driver control section 12 and the backlight data processing section 5 constitute a control section, which controls driving of the liquid crystal panel 1 and the backlight device 2 in accordance with an inputted video signal.

A video signal that the video signal input section 6 receives via an antenna etc. (not illustrated) is a composite video signal including a color signal indicative of a color of an image to be displayed, a luminance signal indicative of luminance of each pixel, and sync signals etc.

The composite video signal inputted to the video signal processing section 6 is supplied only to the RGB signal processing section 8.

The RGB signal processing section 8 converts the composite video signal received from the video signal input section 6 into an RGB separate signal by subjecting the composite video signal to chroma process and matrix conversion process etc., and then supplies the obtained RGB separate signal to the color signal correction section 9 which is a stage subsequent to the RGB signal processing section 8. That is, the RGB signal processing section 8 obtains, from the composite video signal that it received, the RGB separate signal indicative of gray levels of respective RGB to be displayed, and then supplies the RGB separate signal to the color signal correction section 9 which is a stage subsequent to the RGB signal processing section 8.

The color signal correction section 9 is configured to convert the received RGB separate signal into a video signal (R′G′B′ separate signal) by subjecting the RGB separate signal to a correction process, which is predetermined based on color reproducibility and a display mode etc. of the liquid crystal panel 1 included in the liquid crystal display device 101. Specifically, the color signal correction section 9 is configured to receive, from a light sensor (not illustrated) included in the liquid crystal display device 101, the result of measurement of intensity (amount) of external light. The color signal correction section 9 calculates, from the result, a change in color reproducibility of the liquid crystal panel 1 caused by the external light, and carries out a color conversion process so that colors to be displayed are optimum for the condition where there is the external light.

The color signal correction section 9 is configured also to (i) recognize a color signal indicative of a particular color such as a color of human skin and correct the value of the color signal to a color that is more favored by a user and (ii) increase or reduce luminance of the entire surface of the display region in accordance with a display mode inputted via a remote controller etc. that accompanies the liquid crystal display device 101.

Then, the color signal correction section 9 supplies the converted video signal (R′G′B′ separate signal) to the subframe generation section 10 which is a stage subsequent to the color signal correction section 9, and to the backlight data processing section 5.

The subframe generation section 10 divides, into three, one frame period on the basis of a signal value of the video signal (R′G′B′ separate signal) received from the color signal correction section 9, to thereby generate three subframes. Data for the three subframes are supplied to the data delay processing section 11, which is a stage subsequent to the subframe generation section 10.

Note here that each of the three subframes is defined as a frame period that includes data (luminance level of each color) to be displayed in a single subfield, in a case where a single TV field (e.g., 60 Hz) is divided into three subfields (each of which is 180 Hz). Note that, in the following description, a subframe includes data to be displayed.

It is possible to divide a single frame period into the three subframes in various manners. For example, a single frame period is divided so that (i) a first subframe includes entire G (green) data, part of R (red) data, and part of B (blue) data, (ii) a second subfield includes all the rest of the R (red) data, which was not displayed in the first subfield, and another part of the B (blue) data, and (iii) a third subframe includes all the rest of the B (blue) data, which was not displayed in the second subframe.

The data delay processing section 11 is a processing section that delays data of the instruction signals outputted from the driver control section 12 to the liquid crystal panel 1 so that the timing of operation of the liquid crystal panel 1 matches the timing of operation of the backlight device 2.

Specifically, the data delay processing section 11 controls, in accordance with the sync signals included in the composite video signal received from the video signal input section 6 and with a backlight illumination timing signal received from the backlight data processing section 5, the timings at which the data for the three subframes supplied from the subframe generation section 10 are outputted to the driver control section 12.

In accordance with the data for the three subframes received from the data delay processing section 11, the driver control section 12 supplies, to the source driver 3 and the gate driver 4, the instruction signals for driving the liquid crystal panel 1.

Meanwhile, the backlight data processing section 5 refers to data stored in advance in the LUT 7 in accordance with the video signal (R′G′B′ separate signal) from the color signal correction section 9, and supplies, to the backlight device 2, an instruction signal for area active driving.

As described above, the liquid crystal display device 101 carries out area active driving of the backlight device 2 in accordance with a video signal to be displayed on the liquid crystal panel 1.

The following description discusses the subframe generation section 10 in detail.

### <Detailed Description of Subframe Generation Section>

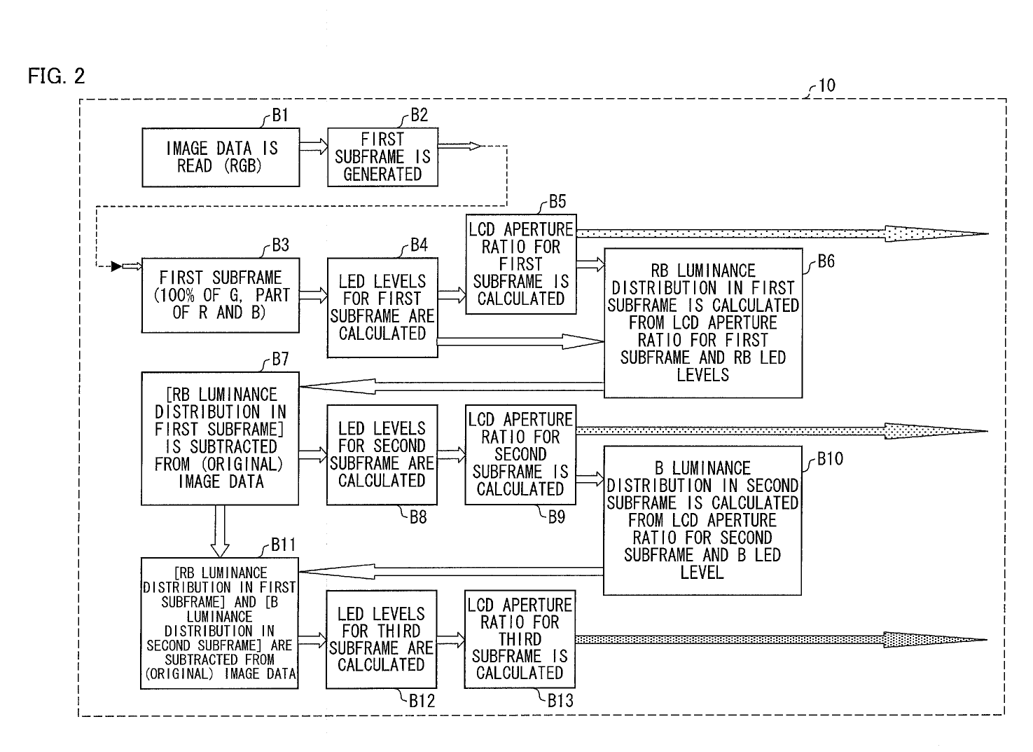

FIG. 2 is a block diagram schematically illustrating process blocks in the subframe generation section shown in FIG. 1.

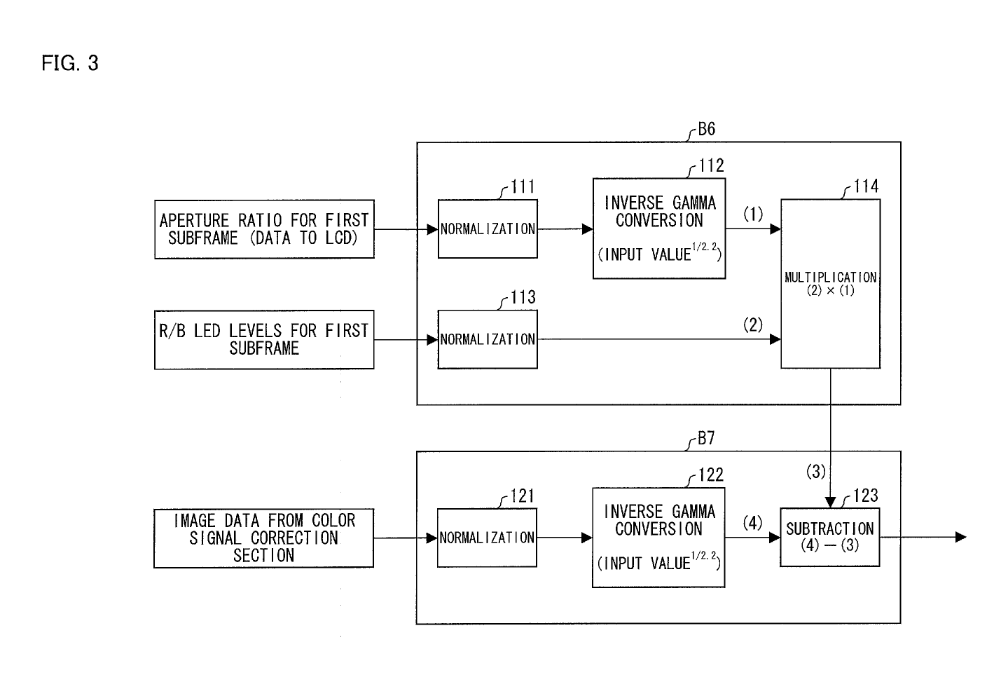

FIG. 3 is a block diagram schematically illustrating the sixth and seventh process blocks shown in FIG. 2.

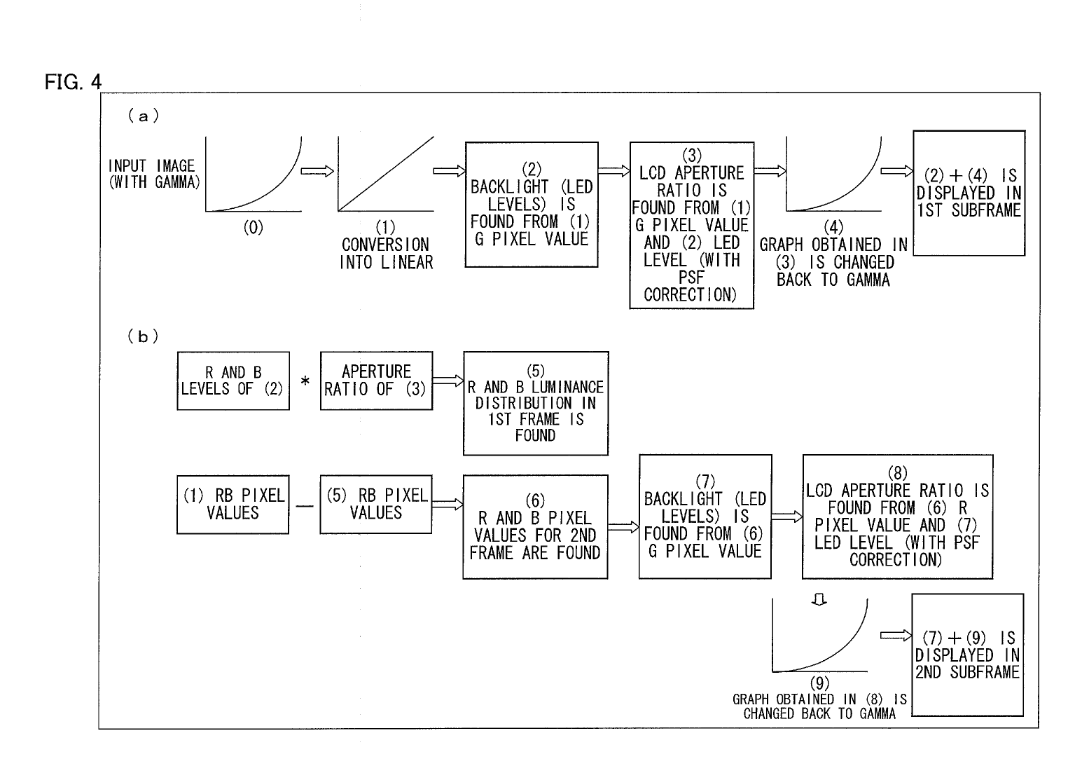

FIG. 4 is a view describing how processes for displays in subframes are carried out. (a) of FIG. 4 shows how processes for a display in the first subframe are carried out. (b) of FIG. 4 shows how processes for a display in the second subframe are carried out.

As illustrated in FIG. 2, the subframe generation section 10 includes first to thirteenth process blocks B1 to B13. The subframe generation section 10 is configured to generate data for each of the three subframes (i.e., LCD aperture ratio for each subframe) through these process blocks, and output the data.

First, in the first process block B1, image data (RGB value) is read. In the second process block B1, the image data thus read is divided into three subframes in accordance with a certain rule. How the image data is divided is described later.

In the third process block B3, the first subframe is set so as to include 100% of G (green) data, part (including 0%) of R (red) data and part (including 0%) of B (blue) data. In the fourth process block B4, LED levels for the first subframe are calculated. The LED levels for the first subframe are supplied to the fifth process block B5 and to the sixth process block B6.

Then, in the fifth process block B5, an LCD aperture ratio for the first subframe is calculated in consideration of the LED level for the first subframe received from the fourth process block B4. The LCD aperture ratio for the first subframe is supplied to the sixth process block B6. The LCD aperture ratio for the first subframe is supplied to the data delay processing section 11.

In the sixth process block B6, R and B luminance distribution in the first subframe is calculated from the LCD aperture ratio for the first subframe and R (red) and B (blue) LED levels. Details of the calculation are described later.

Further, in the seventh process block B7, the R and B luminance distribution in the first subframe, which was calculated in the sixth process block B6, is subtracted from (original) image data. Details of the calculation are described later.

Note here that the LCD aperture ratio means transmittance of each pixel for light from the backlight. Further, luminance of an image displayed on an LED backlight TV system employing area control is a luminance obtained by multiplying luminance (0% to 100%) of the backlight by an LCD aperture ratio (0% to 100%).

For example, in the first subframe, the backlight (LED levels) and the LCD aperture ratio are found on the basis of G (green) data of an input image, and a display is carried out with the LED levels and the LCD aperture ratio thus found. Note, however, that an R (red) backlight and/or a B (blue) backlight may be turned on when the display is carried out. That is, since the R LED and/or the B LED is turned on with the LCD aperture ratio based on the G, the R and B of a displayed image may be not accurate because of the LCD aperture ratio and the LED levels corrected using PSF (point spread function). This is because the R and B have been overcorrected. For correction of such overcorrection, the LCD aperture ratio for the first subframe and luminance distribution of the R LED and the B LED in the first subframe are always being calculated.

Then, in the eighth process block B8, LED levels for the second subframe are calculated. The LED levels for the second subframe are supplied to the ninth process block B9.

Then, in the ninth process block B9, an LCD aperture ratio for the second subframe is calculated in consideration of the LED level for the second subframe received from the eighth process block B8. The LCD aperture ratio for the second subframe is supplied to the tenth process block B10. The LCD aperture ratio for the second subframe is supplied to the data delay processing section 11.

In the tenth process block B10, R and B luminance distribution in the second subframe is calculated from the LCD aperture ratio (hereinafter referred to as an LCD value) for the second subframe and the B (blue) LED level. The calculation is the same as that in the sixth process block B6.

Further, in the eleventh process block B11, the B luminance distribution in the second subframe calculated in the tenth process block B10 is subtracted from the (original) image data. The calculation is the same as that in the seventh process block B7.

Specifically, in the second subframe, all the rest of the R, which was not displayed in the first subframe, is displayed. The aperture ratio for the second subframe is based on this R data. This aperture ratio needs to be subjected to correction of overcorrection that has occurred in the first subframe. That is, (i) amount by which the aperture ratio has been overcorrected is found by subtracting, from the R data of the input image, luminance distribution obtained from the luminance distribution in the first subframe and the LCD aperture ratio for the second subframe which LCD aperture ratio is “before the correction of overcorrection” and (ii) the amount thus found is reflected on the LCD aperture ratio for the second subframe. In this way, a final LCD aperture ratio for the second subframe is found. This makes it possible to correct the overcorrection of the R.

Next, in the twelfth process block B12, LED levels for the third subframe are calculated. The LED levels for the third subframe are supplied to the thirteenth process block B13.

Then, in the thirteenth process block B13, an LCD aperture ratio for the third subframe is calculated in consideration of the LED level for the third subframe received from the twelfth process block B12. The LCD aperture ratio for the third subframe is supplied to the data delay processing section 11.

As described above, in the third subframe, all the rest of the B, which was not displayed in the first and second subframes, is displayed. For correction of overcorrection, the LCD aperture ratio here is also subjected to the same process as that carried out in the second subframe.

The following description discusses, in detail, the processes in the sixth process block B6 and the seventh process block B7.

As illustrated in FIG. 3, the sixth process block B6 includes: a normalization section 111 which normalizes the LCD aperture ratio (data to LCD) for the first subframe; an inverse gamma conversion section 112 which carries out inverse gamma conversion of normalized data; a normalization section 113 which normalizes R and B LED levels for the first subframe; and a multiplication section 114 which multiplies data (1) obtained in the inverse gamma conversion section 112 by data (2) obtained in the normalization section 113.

Further, as illustrated in FIG. 3, the seventh process block B7 includes: a normalization section 121 which normalizes image data received from the color signal correction section 9; an inverse gamma conversion section 122 which carries out inverse gamma conversion of normalized data; and a subtraction section 123 which subtracts data (3) obtained in the multiplication section 114 of the sixth process block B6 from data (4) obtained in the inverse gamma conversion section 122.

Specifically, in FIG. 3, the LCD aperture ratio (data to LCD) for the first subframe supplied to the sixth process block B6 is an RGB gray level (for example, in a case of 8 bit, a value of 0 to 225). The sixth process block B6 calculates, in the normalization section 111, a value of 0 to 1 from the RGB level. The value thus calculated is subjected to inverse gamma conversion (here, raised to the 1/2.2-th power) in the inverse gamma conversion section 112 so as to be linear as light. This is for LEDs to emit light that is linear with respect to the values of signals that the LEDs receive.

On the other hand, the R and B LED levels for the first subframe supplied to the sixth process block B6 are also RGB gray levels. The LED levels are normalized by the normalization section 113 to be dealt with in this process block.

The sixth process block B6 calculates luminance distribution to be observed when an image is actually displayed, by multiplying, in the multiplication section 114, the data (1) obtained from the inputted LCD aperture ratio by the data (2) obtained from the LED levels.

Similarly, the seventh process block B7 receives an RGB gray level of image data from the color signal correction section 9. As is the case with the sixth process block B6, the RGB gray level is normalized in the normalization section 121 and subjected to inverse gamma conversion in the inverse gamma conversion section 122, so as to be dealt with as a value that is linear with respect to light.

Then, in the seventh process block B7, RGB gray levels to be displayed in the second and later subframes can be found in the subtraction section 123 by subtracting, from the data (4) representing the value found in this process block, the data (3) representing the luminance distribution found in the sixth process block B6.

The following description briefly discusses how processes for a display in the liquid crystal display device 101 are carried out.

The processes for a display in the first subframe are carried out in the following manner.

As shown in (0) in (a) of FIG. 4, a graph showing a relationship between gray levels and luminance levels of an input image is a gamma curve. The graph is converted into a linear graph in (1). Next, in (2), LED levels (luminance levels) of a backlight are found from a G pixel value (gray level) on the linear graph obtained in the (1). In (3), an LCD aperture ratio is found from the G pixel value of the (1) and an LED level found in the (2). The LCD aperture ratio is calculated with PSF correction. Then, in (4), the graph showing the relationship between the gray levels and luminance levels is changed back from the linear graph to a gamma curve in accordance with the LCD aperture ratio found in the (3). Lastly, the first subframe is displayed in accordance with the LED levels found in the (2) and the graph obtained in the (4) which graph is a gamma curve showing a relationship between gray levels and luminance levels.

The processes for a display in the second subframe are carried out in the following manner.

In (5) in (b) of FIG. 4, R and B luminance distribution in the first subframe is found by multiplying the R and B LED levels found in the (2) in (a) of FIG. 4 by the LCD aperture ratio found in the (3). In (6), R and B pixel values for the first frame are found by subtracting, from the R and B pixel values found from the graph of the (1) in (a) of FIG. 4, R and B pixel values obtained from the luminance distribution found in the (5). Then, in (7), an LED level of the backlight is found from the R and B pixel values found in the (6). In (8), an LCD aperture ratio is found from the R pixel value found in the (6) and the LED level found in (7). The LCD aperture ratio is calculated with PSF correction. Then, in (9), the graph showing a relationship between gray levels and luminance levels is changed back from a linear graph to a gamma curve in accordance with the LCD aperture ratio found in the (8). Lastly, the second subframe is displayed in accordance with the LED levels found in the (7) and the graph obtained in the (9) which graph is the gamma curve showing a relationship between gray levels and luminance levels.

According to the processes for displays shown in (a) and (b) of FIG. 4, amount by which the R and B have been overcorrected in the first subframe can be found by (i) calculating luminance distribution based on the LED levels and LCD aperture ratio calculated in the first subframe (in a case of the second subframe) and (ii) using, as original data for the second subframe, a difference between original image data and the luminance distribution thus calculated. This is carried out every subframe. B luminance distribution is calculated based on the LED level calculated in the second subframe (in the case of the second subframe) and the aperture ratio for the second subframe, and a difference between the original image data and the luminance distribution in the first and second subframes is used as original image data for the third subframe.

<Description of Area Active Drive Control of Backlight>

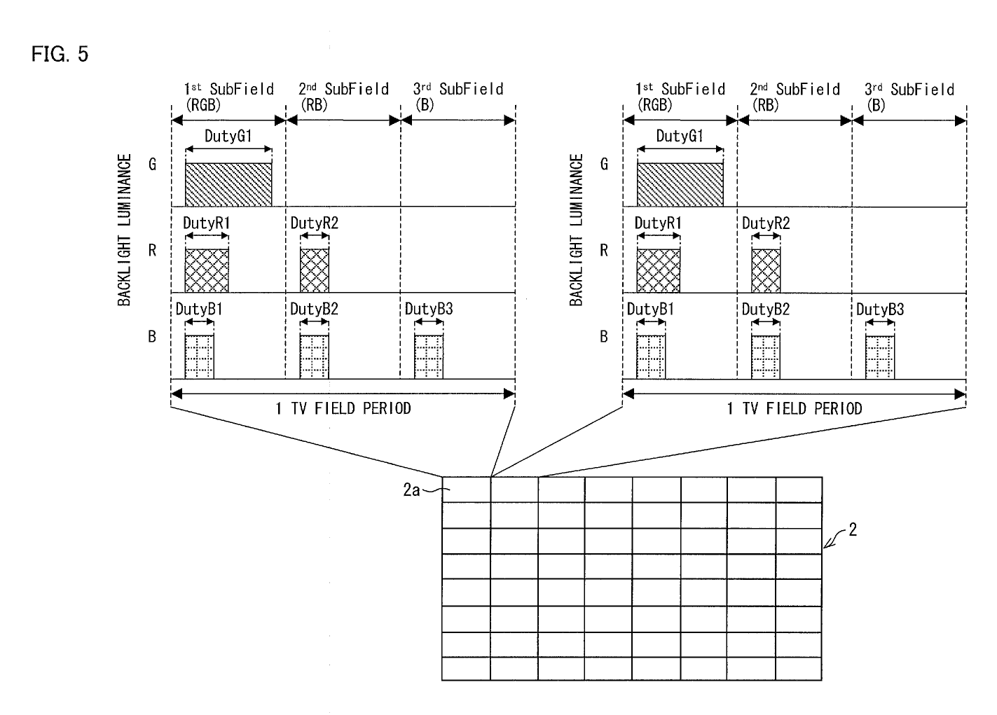

FIG. 5 is a view for describing control of a backlight included in the liquid crystal display device shown in FIG. 1.

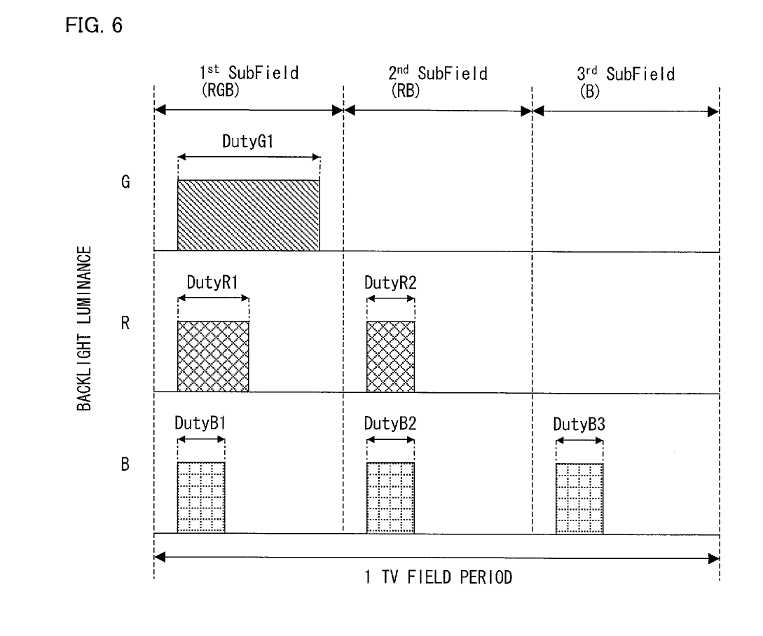

FIG. 6 is a view showing processes carried out for one area of an LED backlight.

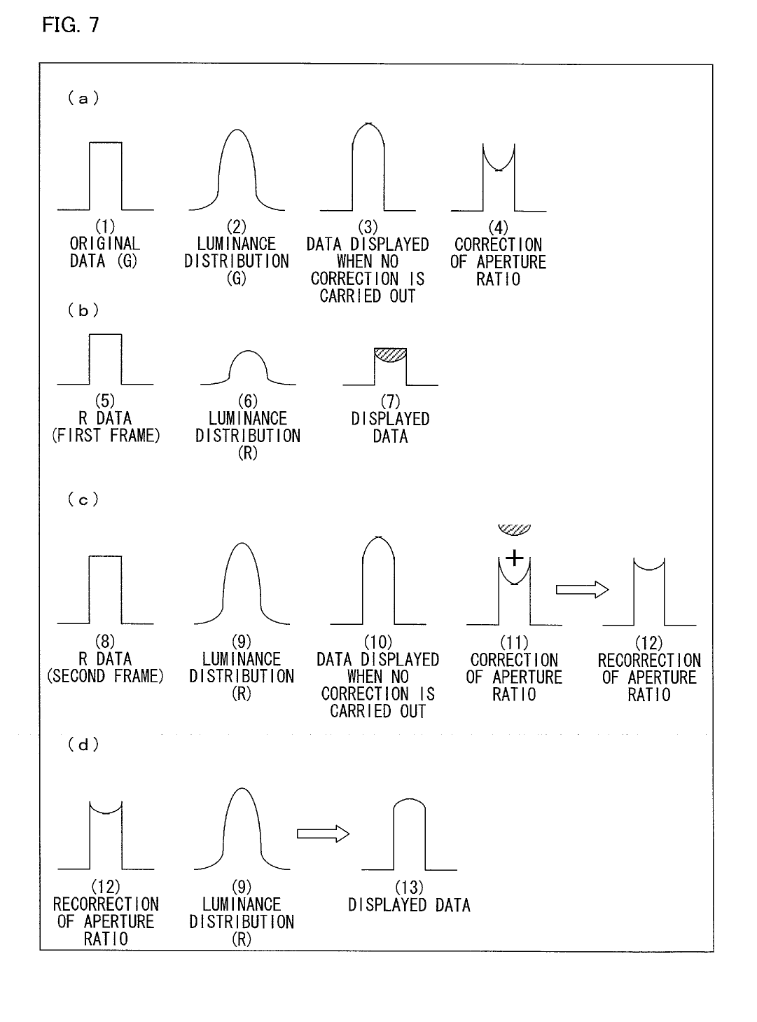

FIG. 7 is a view illustrating how processes of correction of aperture ratios of the liquid crystal display device are carried out when the processes shown in FIG. 6 are applied.

In the liquid crystal display device 101 configured as above, the backlight device 2 has a plurality of light emitting areas 2a (see FIG. 5). The light emitting areas 2a are constituted by a predetermined number of LEDs.

The liquid crystal display device 101 is configured to control, for each of the light areas 2a of LEDs, driving of backlights so that the backlights emit light in their corresponding subframes. This makes it possible, even if color breaking occurs which is a problem to be solved, to prevent the color breaking from spreading out from a small light emitting area 2a of LEDs, and thus possible to reduce color breaking to the minimum. Accordingly, it is possible to carry out correction according to luminance distribution of the LEDs while preventing color breaking.

The following description specifically discusses, with reference to FIGS. 6 and 7, setting of division into subframes.

FIG. 6 shows three subframes (each subfield is 180 Hz), into which a single TV field (e.g., 60 Hz) is divided and in which respective contents (colors) of RGB are displayed. A content (color) to be displayed in a single TV field is a sum of the colors displayed in the subframes.

How a single TV field is divided into the three subframes is described below.

Division is carried out for each single area (a light emitting area 2a shown in FIG. 5) which is to be subjected to area control. A ratio at which a single TV field is divided depends on the values of all the pixels (RGB) in the single area.

(G of GRB Frame (First Subframe))

All the G data in a single TV field should be displayed in this subframe. Therefore, the liquid crystal panel 1 and the backlight device 2 have levels corresponding to displaying all the G data.

(R of GRB Frame (First Subframe))

The level of the backlight is set so that, in liquid crystal data which is G data, the R luminance equals the lowest of the R luminances in the pixels in the single area. In a case where there are no R data in that area, no R backlight is turned on.

(B of GRB Frame (First Subframe))

The level of the backlight is set so that, in the liquid crystal data which is G data, the B luminance equals the lowest of the B luminances in the pixels in the single area. In a case where there are no B data in that area, no B backlight is turned on.

(R of RB Frame (Second Subframe))

The liquid crystal panel 1 and the backlight device 2 have levels corresponding to displaying all the rest of the R data, which was not displayed in the first subframe of the single TV field.

(B of RB Frame (Second Subframe))

The level of the backlight is set so that, in liquid crystal data which is R data set as above, so that the B luminance equals the lowest of the luminances of all the rest of the B data which was not displayed in the first subframe of the single TV field for the single area.

(B of B Frame (Third Subframe))

The liquid crystal panel 1 and the backlight device 2 have levels corresponding to displaying all the rest of the B data, which was not displayed in the first and second subframes of the single TV field.

As described above, in a case where three subframes as shown in FIG. 6 are generated, the LCD aperture ratio for one (G main) of the subframes is determined based on the value of the G. The LCD aperture ratio is corrected in accordance with luminance distribution (PSF) of a single LED, and, in accordance with the LCD aperture ratio thus corrected, original data is corrected. This is carried out based on the luminance of the G LED. With this LCD aperture ratio, not only a G LED is turned on, but also R and B LEDs are turned on to a possible extent. Note however that, since the aperture ratio is corrected so as to correspond to the G LED, R data and/or B data is not corrected accurately. In another subframe, processes are carried out so as to display the rest of the R, which was not displayed in the G main subframe. Note however that, usually, the aperture ratio closed in that subframe is corrected. Therefore, even when all the subframes are displayed, the R and/or B that was not corrected accurately in the G main subframe may not be displayed accurately. To avoid this, the process for correcting overcorrection of the LCD aperture ratio is necessary.

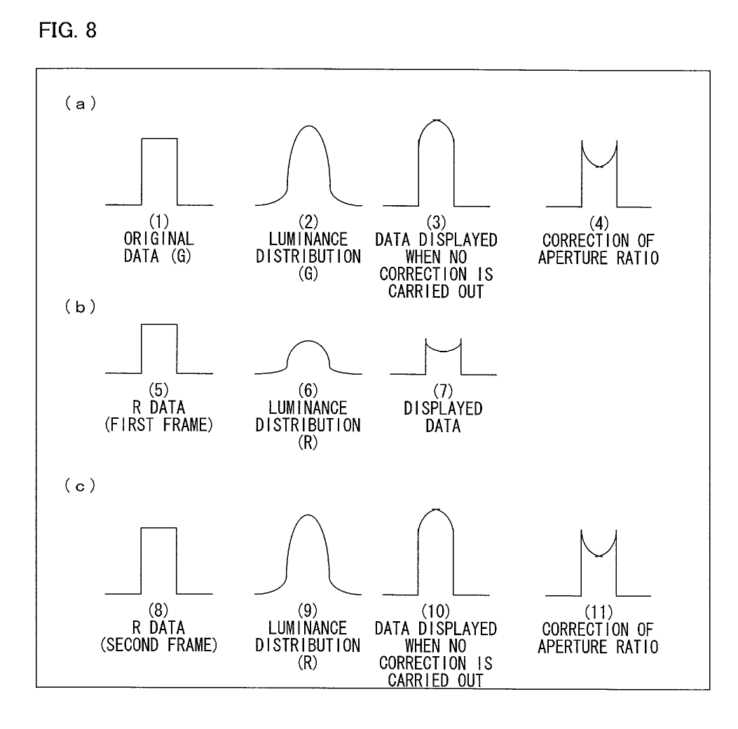

The following description discusses, with reference to (a) to (d) of FIG. 7, the processes for correcting overcorrection of the LCD aperture ratio. Prior to the description, a conventional correction of LED aperture ratios and its problem are described below with reference to (a) to (c) of FIG. 8.

(a) of FIG. 8 shows a first correction process.

In the first subframe, an aperture ratio is corrected on the basis of data (green) of (1). In a case where (i) there is the data of (1) and (ii) an LED (LED corresponding to green) emits light with the luminance distribution of (2) right below the data of (1), the LED illuminates as shown in (3) if no aperture ratio correction is carried out. To prevent this, the aperture ratio is corrected as shown in (4).

(b) of FIG. 8 shows a second correction process.

In the first subframe, Red and Blue LEDs may be turned on with the aperture ratio of the (4). However, a display of R and B may be carried out with a luminance that is lower than the Green LED. If this is the case, overcorrection occurs, and this results in a display as shown in (7).

(c) of FIG. 8 shows a third correction process.

In the second subframe, the aperture ratio is corrected on the basis of data (red) of (8). This causes the R data in the second subframe to be accurately corrected and displayed. However, the overcorrection occurred in the first subframe is not corrected.

In contrast, according to the correction process for overcorrection of LCD aperture ratios in accordance with the present invention as below, accurate color reproduction can be achieved by, in a display system that employs a field sequential system and carries out an area active drive control with use of an LED backlight, calculating data for subframes that constitute a single frame and correcting luminance distribution of LEDs in the subframes as a whole.

(a) of FIG. 7 shows a first correction process.

In the first subframe, an aperture ratio is corrected on the basis of data (Green) of (1). In a case where (i) there is the data of (1) and (ii) an LED (LED corresponding to green) emits light with luminance distribution of (2) right below the data of (1), the LED illuminates as shown in (3) if no aperture ratio correction is carried out. To prevent this, the aperture ratio is corrected as shown in (4).

(b) of FIG. 7 shows a second correction process.

In the first subframe, Red and Blue LEDs may be turned on with the aperture ratio of the (4). However, a display of R and B may be carried out with a luminance lower than that of the Green LED. If this is the case, overcorrection occurs, and this results in a display as shown in (7). Here, as shown in (7), amount (shaded portion) by which the aperture ratio has been overcorrected is calculated from the data of aperture ratio correction in the (4) and the luminance distribution of (6). Specifically, a difference (shaded portion in (7) of FIG. 7) between (i) a signal to be displayed ((7) of FIG. 7), which signal is obtained from the aperture ratio ((4) of FIG. 7) corrected in the first subframe and the luminance distribution ((6) of FIG. 7) of a light source corresponding to a video signal of the second color included in the first subframe and (ii) the video signal ((5) of FIG. 7) of the second color included in the first subframe is found.

(c) of FIG. 7 shows a third correction process.

In the second subframe, the aperture ratio is corrected on the basis of data (red) of (8). This causes R data in the second subframe to be accurately corrected and displayed. However, the overcorrection of the aperture ratio occurred in the first subframe is not corrected (as shown in (11)). The overcorrection occurred in the first subframe is re-corrected (as shown in (12)) by finding an aperture ratio for this subframe in consideration of the amount of overcorrection (shaded portion) found from displayed data shown in the (7). Specifically, the aperture ratio ((11) of FIG. 7) corrected in the second subframe is corrected according to the difference (shaded portion in (7) of FIG. 7) between the signals found in the first subframe (see (12) of FIG. 7).

In a case of luminance distribution shown in (9), data is displayed as shown in (10) as is the case with the (3) in (a) of FIG. 7, if no aperture ratio correction is carried out.

On the other hand, if the aperture ratio is re-corrected as shown in the (12), in a case of the luminance distribution shown in the (9), data is displayed as shown in (13) (see (d) of FIG. 7).

It is clear from the displayed data shown in the (13) in (d) of FIG. 7 that, although the vicinity of the peak of the luminance distribution somewhat curves outward, the R data in the second subframe is displayed with an appropriate luminance level.

It should be noted that the above correction has the following problem. That is, in a case where, in the second subframe, (i) the aperture ratio for the second color with which all the video signals are displayed is appropriately corrected but (ii) the corrected aperture ratio for the second color is smaller than an aperture ratio obtained on the basis of a video signal of the third color, the third subframe will be insufficient in luminance.

If this is the case, the image display device can further be configured such that the subframe generation section: finds a first difference between (i) a signal to be displayed, which signal is obtained from the first aperture ratio corrected by the first aperture ratio correction section in the first subframe and luminance distribution of a light source corresponding to a video signal of the third color included in the first subframe and (ii) the video signal of the third color included in the first subframe; finds a second difference between (a) a signal to be displayed, which signal is obtained from the second aperture ratio corrected by the second aperture ratio correction section in the second subframe and luminance distribution of a light source corresponding to a video signal of the third color included in the second subframe and (b) the video signal of the third color included in the second subframe; and corrects, according to a sum of the first and second differences found in the first and second subframes, the third aperture ratio corrected by the third aperture ratio correction section in the third subframe.

According to the configuration, the third aperture ratio corrected in the third subframe is corrected according to the sum of the differences. This makes it possible to compensate for lack of luminance when one frame is taken as a whole, and thus possible to appropriately display the video signal of the third color.

Accordingly, a display method for the foregoing image display device is a display method for the image display device including (i) display means having a display region, the display region being constituted by a plurality of pixels each having light transparency and (ii) a backlight constituted by a plurality of light sources for backlighting the display region of the display means with light of different colors, the image display device displaying an image by controlling, in accordance with an inputted video signal, an aperture ratio indicative of transmittance, of the plurality of pixels of the display means, for the light emitted from the plurality of light sources of the backlight, said method, including the steps of: (1) generating subframes by dividing one frame of the video signal into a first subframe during which at least a light source of a first color emits light, a second subframe during at least a light source of a second color emits light, and a third subframe during which a light source of a third color emits light, the step (1) including a first aperture ratio correction step for correcting, on the basis of a video signal of the first color included in the first subframe, a first aperture ratio corresponding to a pixel of the first color, a second aperture ratio correction step for correcting, on the basis of a video signal of the second color included in the second subframe, a second aperture ratio corresponding to a pixel of the second color, and a third aperture ratio correction step for correcting, on the basis of a video signal of the third color included in the third subframe, a third aperture ratio corresponding to a pixel of the third color; (2) finding a difference between (i) a signal to be displayed, which signal is obtained from the first aperture ratio corrected by the first aperture ratio correction step in the first subframe and luminance distribution of a light source corresponding to a video signal of the second color included in the first subframe and (ii) the video signal of the second color included in the first subframe; and (3) correcting, according to the difference found in the first subframe, the second aperture ratio corrected by the second aperture ratio correction step in the second subframe.

As described earlier, correction of an LCD aperture ratio based on luminance distribution of an LED is generally carried out within a single frame. Note however that, in a case of the field sequential system, the correction needs to be carried out within the three subframes that constitute a single frame. In this case, the R and B data can be displayed accurately by (i) finding R and B (LCD aperture ratio+luminance distribution) to be displayed in the foregoing G main subframe, (ii) finding amount of overcorrection and (iii) carrying out correction of the overcorrection in the subsequent second and third subframes.

It should be noted that, although an example of a color display using three primary colors of RGB is explained in the present embodiment, the present invention is not limited to the three primary colors of RGB. A combination of other colors for achieving a color display can be employed. For example, even in a case where three colors of Y (yellow), C (cyan) and M (magenta) are used for a color display, the same effects can be obtained by the same processes.

The present invention is not limited to the descriptions of the respective embodiments, but may be altered within the scope of the claims. An embodiment derived from a proper combination of technical means disclosed in different embodiments is encompassed in the technical scope of the invention.

The present invention is usable in a display device capable of color display. In particular, the present invention is usable in a liquid crystal display device that carries out a color display by a field sequential system.

1. An image display device comprising:
display means having a display region, the display region being constituted by a plurality of pixels each having light transparency; and
a backlight constituted by a plurality of light sources for backlighting the display region of the display means with light of different colors,
said image display device displaying a color image by controlling, in accordance with an inputted video signal, an aperture ratio indicative of transmittance, of the plurality of pixels in the display means, for the light emitted from the plurality of light sources of the backlight,
wherein one frame of the video signal is divided into a first subframe during which at least a light source of a first color emits light, a second subframe during which at least a light source of a second color emits light, and a third subframe during which a light source of a third color emits light,
a first aperture ratio corresponding to a pixel of the first color is corrected on the basis of a video signal of the first color included in the first subframe,
a second aperture ratio corresponding to a pixel of the second color is corrected on the basis of a video signal of the second color included in the second subframe,
a third aperture ratio corresponding to a pixel of the third color is corrected on the basis of a video signal of the third color included in the third subframe,
a difference between (i) a signal to be displayed, which signal is obtained from the first aperture ratio corrected in the first subframe and luminance distribution of a light source corresponding to a video signal of the second color included in the first subframe and (ii) the video signal of the second color included in the first subframe is found, and
the second aperture ratio corrected in the second subframe is corrected according to the difference found in the first subframe.

2. An image display device comprising:
display means having a display region, the display region being constituted by a plurality of pixels each having light transparency; and
a backlight constituted by a plurality of light sources for backlighting the display region of the display means with light of different colors,
said image display device displaying a color image by controlling, in accordance with an inputted video signal, an aperture ratio indicative of transmittance, of the plurality of pixels in the display means, for the light emitted from the plurality of light sources of the backlight,
said image display device further comprising:
a subframe generation section for dividing one frame of the video signal into a first subframe during which at least a light source of a first color emits light, a second subframe during which at least a light source of a second color emits light, and a third subframe during which a light source of a third color emits light,
the subframe generation section including
a first aperture ratio correction section for correcting, on the basis of a video signal of the first color included in the first subframe, a first aperture ratio corresponding to a pixel of the first color,
a second aperture ratio correction section for correcting, on the basis of a video signal of the second color included in the second subframe, a second aperture ratio corresponding to a pixel of the second color, and
a third aperture ratio correction section for correcting, on the basis of a video signal of the third color included in the third subframe, a third aperture ratio corresponding to a pixel of the third color, and
the subframe generation section finding a difference between (i) a signal to be displayed, which signal is obtained from the first aperture ratio corrected by the first aperture ratio correction section in the first subframe and luminance distribution of a light source corresponding to a video signal of the second color included in the first subframe and (ii) the video signal of the second color included in the first subframe, and correcting, according to the difference found in the first subframe, the second aperture ratio corrected by the second aperture ratio correction section in the second subframe.

3. The image display device according to claim 2, wherein the subframe generation section:
finds a first difference between (i) a signal to be displayed, which signal is obtained from the first aperture ratio corrected by the first aperture ratio correction section in the first subframe and luminance distribution of a light source corresponding to a video signal of the third color included in the first subframe and (ii) the video signal of the third color included in the first subframe;
finds a second difference between (a) a signal to be displayed, which signal is obtained from the second aperture ratio corrected by the second aperture ratio correction section in the second subframe and luminance distribution of a light source corresponding to a video signal of the third color included in the second subframe and (b) the video signal of the third color included in the second subframe; and
corrects, according to a sum of the first and second differences found in the first and second subframes, the third aperture ratio corrected by the third aperture ratio correction section in the third subframe.

4. The image display device according to claim 2, wherein the first color is green (G), the second color is red (R), and the third color is blue (B).

5. The image display device according to claim 2, wherein the first color is yellow (Y), the second color is cyan (C), and the third color is magenta (M).

6. The image display device according to claim 2, wherein the plurality of light sources of the backlight are driven such that light sources in respective predetermined areas are driven independently of each other.

7. A display method for an image display device, the image display device including (i) display means having a display region, the display region being constituted by a plurality of pixels each having light transparency and (ii) a backlight constituted by a plurality of light sources for backlighting the display region of the display means with light of different colors, the image display device displaying an image by controlling, in accordance with an inputted video signal, an aperture ratio indicative of transmittance, of the plurality of pixels of the display means, for the light emitted from the plurality of light sources of the backlight,
said method, comprising the steps of:
(1) generating subframes by dividing one frame of the video signal into a first subframe during which at least a light source of a first color emits light, a second subframe during at least a light source of a second color emits light, and a third subframe during which a light source of a third color emits light,
the step (1) including
a first aperture ratio correction step for correcting, on the basis of a video signal of the first color included in the first subframe, a first aperture ratio corresponding to a pixel of the first color,
a second aperture ratio correction step for correcting, on the basis of a video signal of the second color included in the second subframe, a second aperture ratio corresponding to a pixel of the second color, and
a third aperture ratio correction step for correcting, on the basis of a video signal of the third color included in the third subframe, a third aperture ratio corresponding to a pixel of the third color;
(2) finding a difference between (i) a signal to be displayed, which signal is obtained from the first aperture ratio corrected by the first aperture ratio correction step in the first subframe and luminance distribution of a light source corresponding to a video signal of the second color included in the first subframe and (ii) the video signal of the second color included in the first subframe; and
(3) correcting, according to the difference found in the first subframe, the second aperture ratio corrected by the second aperture ratio correction step in the second subframe.

8. The image display device according to claim 1, wherein the first color is green (G), the second color is red (R), and the third color is blue (B).

9. The image display device according to claim 1, wherein the first color is yellow (Y), the second color is cyan (C), and the third color is magenta (M).

10. The image display device according to claim 1, wherein the plurality of light sources of the backlight are driven such that light sources in respective predetermined areas are driven independently of each other
